(19) United States
(12) Patent Application Publication
(10) Pub. No.: US 2008/0121067 A1
(43) Pub. Date: May 29, 2008

(54) CONTROL KNOB ASSEMBLY

(75) Inventor: Goran Uhlin, Lagan (SE)

Correspondence Address: PEARNE & GORDON LLP, 1801 EAST 9TH STREET, SUITE 1200, CLEVELAND, OH, 44114-3108, US

(73) Assignee: Aktiebolaget Electrolux, Stockholm (SE)

(21) Appl. No.: 11/771,194

(22) Filed: Jun. 29, 2007

(30) Foreign Application Priority Data
Dec. 30, 2004 (SE) 0403219-9

(51) Int. Cl. G05G 5/05; G05G 1/10; G05G 5/06

(52) U.S. Cl. 74/511 R; 74/554; 74/553

(57) ABSTRACT

A control knob assembly (16) including a housing having a front member (12) and a rear member (32). A control knob (22) is mounted for turning and axial movement in an opening (36) in the front member (12), said turning and axial movements being associated with control settings to be transferred to a control shaft (52) of a control member (18) generating electric control information. The control knob (22) and the control shaft (52) are interconnected so as to allow for excess force applied axially on the control knob (22) towards the control shaft (52) to be taken by the housing (12, 32).

The invention relates to a control knob assembly including a housing having a front member and a rear member, a control knob being mounted for turning and axial movement in an opening in the front member, said turning and axial movements being associated with control settings to be transferred to a control shaft of a control member generating electric control information.

A control knob assembly of the kind referred to is very often used in a washing machine in association with a program selector arrangement. In particular in connection with professional washing machines used in laundromats and in residential laundry facilities excess wear and hard handling may occur which could also involve damage to the program selector arrangement caused by violent handling of the control knob. Accordingly, there is an object of the invention to minimize the effects of such violent handling and to provide a control knob assembly which is robust and which can stand hard handling in connection with the setting of various programs by use of the control knob. The object is achieved in a control knob assembly of the kind indicated which has obtained the characterizing features indicated in the appending claim 1. Preferred embodiments are included in the associated sub-claims.

The invention will be described more in detail in connection with a preferred embodiment with reference to the enclosed drawings in which:

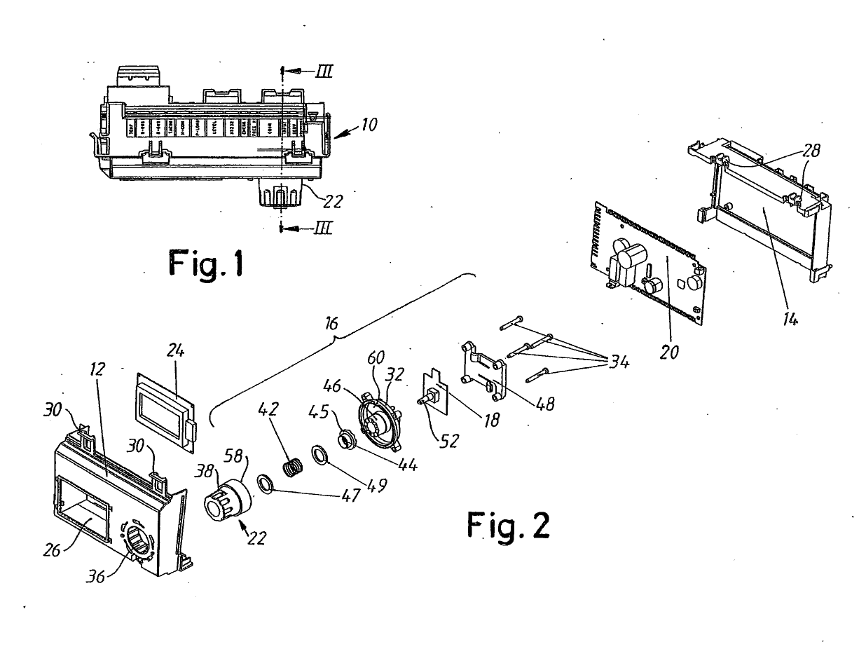

FIG. 1 is a top view of a control knob assembly incorporated in a program selector arrangement for a laundry washing machine;

FIG. 2 is an exploded view of the arrangement of FIG. 1, and

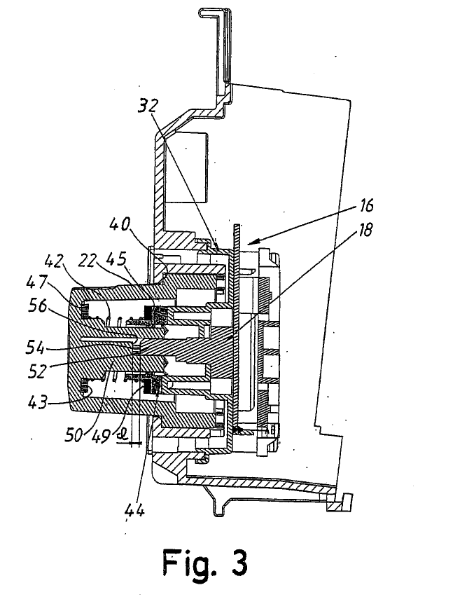

FIG. 3 is a section along the line III-III in FIG. 1.

The program selector arrangement shown in the drawings includes a housing 10 comprising a front member 12 and a rear cover 14. In the housing 10 are mounted a control knob assembly 16 with an electronic program selector 18 which generates electric signals to a CPU mounted on a printed circuit board 20. The signals are generated in correspondence to program settings made by operation of a control knob 22 included in the control knob assembly 16. Program settings are shown on a display 24 mounted in an opening 26 in the front member 12 of the housing. The front member 12 and the rear cover 14, forming the housing, are assembled by means of snap-in fastening members 28, 30 provided on the respective housing member 12, 14.

In addition to the control knob 22 and the electronic program selector 18, the control knob assembly 16 comprises a rear housing member 32 which is fixed to the front member 12 by means of suitable screws 34. The control knob 22 is mounted for turing and axial movement in an opening 36 provided in the front member 12. A forward portion of the knob 22 is adapted to properly fit in the opening 36 whereas a rear portion of the knob 22 has an enlarged diameter creating a flange 38 adapted to abut an annular surface 40, see FIG. 3, interior of the front member 12. In this way complete removal of the control knob 22 is prevented which assists in protecting the program selector arrangement against possible damage from intrusive activities. A coil spring 42 is provided to bias the control knob 22 in a direction out of the opening 36 into the position where the flange 38 engages the annular surface 40.

The control knob assembly 16 comprises an indexing arrangement which determines a number of fixed angular positions of the control knob 22 corresponding to selected program settings. The indexing arrangement comprises a first indexing member 44 mounted for movement with the control knob 22, and a second indexing member 46 fixedly mounted to the rear housing member 32. The coil spring 42 is adapted to engage at one end with an annular surface 43 provided interior of the control knob 22. The opposite end of the coil spring 42 engages with a corresponding annular surface 45 provided on the first indexing member 44. In order to minimize possible noise caused by turning movement of the control knob 22 a rubber washer 47, 49 is disposed between the respective end of the coil spring 42 and the annular surfaces 43 and 45, respectively.

The electronic program selector 18 is mounted on the back side of the rear housing member 32 and a spring arrangement 48, mounted to the front member 12 together with the rear housing member 32 with the screws 34, secures a kind of floating mounting of the electronic program selector 18.

With particular reference to FIG. 3 the control knob 22 is shown to have a hub portion 50 which cooperates with a shaft 52 of the electronic program selector 18. As can be seen there is an interspace d between the end 54 of the shaft 52 and the bottom 56 of the hub portion 50.

Briefly, a program can be chosen by turning the control knob 22 into a selected one of the indexed positions. Subsequently, the chosen program is then confirmed by pushing the control knob 22 for performing an axial movement thereof. After a distance corresponding the size of the interspace d between the bottom 56 of the hub portion 50 and the end 54 of the shaft 52 the bottom 56 acts on the end 54 to move said shaft 52 a distance to cause the electronic program selector 18 to generate corresponding signals. This movement of the shaft 52 is normal and accepted but if by violent handling the control knob 22 is further pushed the excess force is to be taken care of by the housing 10 instead of by the program selector 18 which then could easily become damaged. Accordingly, this excess force is transferred to the rear housing member 32 by an inner end surface 58 on the control knob 22 engaging with a corresponding surface 60 on the rear housing member 32. This engagement occurs when the control knob 22 has been moved axially a distance that exceeds the interspace d.

In order to further protect the electronic program selector 18 assistance is given by the spring arrangement 48 the spring force of which determines the maximum force that acts on the program selector 18 at the time the control knob 22 is moved axially to a position where the inner end surface 58 engages with the surface 60 on the rear housing member 32.

As has been described above a control knob assembly has been provided which is robust and offers protection against possible violent handling and intrusive activities. The described embodiment is one example of how to carry out the invention. Other possible embodiments are included within the scope of the invention given by the appending claims.

1. Control knob assembly (16) including a housing having a front member (12) and a rear member (32), a control knob (22) being mounted for turning and axial movement in an opening (36) in the front member (12), said turning and axial movements being associated with control settings to be transferred to a control shaft (52) of a control member (18) generating electric control information, characterized in that the control knob (22) and the control shaft (52) are interconnected so as to allow for a certain amount of the control knob and the control shaft for effecting control settings whereas excess force applied axially on the control knob (22) towards the control shaft (18) is transferred to the rear member (32) of the housing (12, 32) leaving control shaft (52) unaffected.

2. Assembly according to claim 1, characterized in that the first spring means (42) are provided to bias the control knob (22) in a direction out of the opening (36) in the front member (12) to a position in which a flange (38) of the control knob (22) abuts an inner surface (40) surrounding said opening (36), wherein the control knob (20 has a hub portion (50) slidingly cooperating with said control shaft (52) and the bottom (56) of the hub portion (50) corresponding to axial movement of the control knob (22) to transfer axial movement for control settings to the control shaft (52).

3. Assembly according to claim 2, characterized in that the hub portion (50) has a surface (58) adapted to cooperated with a corresponding surface (60) on the rear member (32) of the housing when excess force is applied on the control knob (22) towards the control shaft (52).

4. Assembly according to claim 1, characterized in that the control member (18) with the control shaft (52) is mounted to the outside of the rear member (32) of the housing and spring-biased towards the front member (12) of said housing.

5. Assembly according to, claim 1, characterized in that an indexing arrangement is provided for determining fixed angular positions of the control knob (22), said indexing arrangement comprising a first indexing member (44) mounted to follow the movement of the control knob (22), and a second indexing member (46) fixedly mounted to the rear member (32) of the housing.

6. Assembly according to claim 5, characterized in that a first spring means (42) is a coil spring adapted to engage with an annular surface (43) on the first indexing member (44).

7. Assembly according to claim 6, characterized in that a rubber washer (47, 49) is placed between each end of the coil spring (42) and the corresponding annular surface (43, 45) on the control knob (22) and the first indexing member (44), respectively.
